(19) United States
(12) Patent Application Publication
(10) Pub. No.: US 2005/0227896 A1
(43) Pub. Date: Oct. 13, 2005

(54) Multicomponent liquid detergent

(76) Inventors: Horst-Dieter Speckmann, Langenfeld (DE); Hermann Jonke, Duesseldorf (DE); Helga Werner, Rommerskirchen (DE); Johannes Zipfel, Hilden (DE); Sabine Fabian, Neuss (DE); Eva-Maria Wikker, Wesel (DE)

Correspondence Address: HENKEL CORPORATION, THE TRIAD, SUITE 200, 2200 RENAISSANCE BLVD., GULPH MILLS, PA, 19406, US

(21) Appl. No.: 11/145,680

(22) Filed: Jun. 3, 2005

Related U.S. Application Data
(63) Continuation of application No. PCT/EP03/13285, filed on Nov. 26, 2003.

(30) Foreign Application Priority Data
Dec. 6, 2002 (DE) 102 57 387.5

(51) Int. Cl. C11D 17/00

(52) U.S. Cl. 510/392

(57) ABSTRACT

A liquid washing agent composition containing 7.5 wt % to 80 wt % of surfactant and composed of two or more separate sub-compositions, a first sub-composition containing an organci peracid and a second sub-composition containing an enzyme.

### CROSS REFERENCE TO RELATED APPLICATIONS

This application is a continuation under 35 U.S.C. § 365(c) and 35 U.S.C. §120 of international application PCT/EP2003/013285, filed Nov. 26, 2003. This application also claims priority under 35 U.S.C. § 119 of DE 102 57 387.5, filed Dec. 6, 2002.

### BACKGROUND OF THE INVENTION

The present patent application concerns a liquid washing composition that comprises at least two sub-compositions kept separate from one another.

In washing agents in liquid form, especially when they contain water, chemical incompatibility of the individual ingredients can result in negative interactions among those ingredients, and in a decrease in their activity and thus a decrease in the washing performance of the agent as a whole, even if it is stored for only a relatively short time. This decrease in activity affects, in principle, all washing agent ingredients that perform chemical reactions in the washing process in order to contribute to the washing result, in particular bleaching agents and enzymes, although surfactant or sequestering ingredients that are responsible for dissolution processes or complexing steps do not have unlimited storage stability in aqueous systems, especially in the presence of the aforesaid chemically reactive ingredients. One possible remedy is offered, for example, by the fact that the reactivity of the chemically active ingredients is not the same at all pH values, so that the deleterious effect of an ingredient or its decomposition reaction can be minimized by appropriate adjustment of the pH of the agent. One difficulty that then results, however, is that the reactivity minima of the chemically active ingredients do not all occur at the same pH, and stabilization by way of pH is therefore not normally possible for all ingredients simultaneously. A further difficulty results from the fact that a pH which is as close as possible to the reactivity minimum during storage must change under the agent's utilization conditions so that the reactivity of the chemically active ingredients can become higher under washing conditions, thus rendering them capable of making their contribution to the washing result.

To solve this problem, it has been proposed numerous times not to incorporate simultaneously into a liquid washing agent all the washing agent ingredients that are desirable for a good washing result, but rather to make available to the user of the washing agent several components which he or she need not combine until shortly before or during the washing process, and which each contain only mutually compatible ingredients that are used together under utilization conditions.

International Patent Application WO 00/61713 A1, for example, discloses a liquid washing agent that comprises at least two liquid sub-compositions, which are stored separately from one another in a receptacle having at least two chambers and of which at least one comprises an imine or oxaziridine bleach activator and at least one other comprises an alkalizing agent, at least one of the sub-compositions containing a peracid bleaching agent and each sub-composition exhibiting a pH that results in stability. Upon mixing of the sub-compositions, the pH of the final composition rises as a result of the alkalizing agent, so that the bleaching agent and bleach activator react effectively with one another.

European Patent EP 0 807 156 discloses a dispenser having two chambers, the first chamber of which contains an aqueous composition of hydrogen peroxide or an organic peracid having a pH greater than 2 and less than 7, and the second chamber of which contains an acid component, and out of which chambers the contents are discharged, together or successively, onto a surface in such a way that the resulting mixture possesses a pH of at most 2.

International Patent Application WO 94/15465 describes a two-pack system made up firstly of an aqueous aliphatic peracid and secondly of an aqueous hydrogen peroxide solution that contains a corrosion inhibitor, peracid stabilizer, and/or hydrogen peroxide stabilizer. The two solutions are combined to generate a disinfecting agent.

It is proposed in German Patent Application DE 100 24 251 A1 to store, in correspondingly separate fashion in a double-chamber bottle, a bleaching agent that comprises in a first component an aqueous 1-40 wt % imidoperoxocarboxylic acid dispersion, and in a second component a substance mixture that activates the first component, and to mix the two components only upon utilization. The second component, referred to in this document as a pH-regulating buffer solution, comprises an aqueous solution of sodium hydrogencarbonate and sodium carbonate that has been thickened with methylcellulose.

It has now been found, surprisingly, that an optimum is achieved from the standpoint of storage stability and performance of the agent under utilization conditions if a liquid washing agent composition is used that comprises at least two aqueous sub-compositions kept separate from one another, a first sub-composition containing organic peracid and a second sub-composition containing enzyme.

Separation of the sub-compositions is preferably accomplished by the fact that they are present in multi-chamber containers, the number of chambers of the container corresponding to the number of sub-compositions and only one of the sub-compositions being present in each of the chambers. A further subject of the invention is therefore a combination of a liquid washing agent composition defined here that comprises at least two, preferably exactly two, liquid sub-compositions, and a multi-chamber container, the number of chambers of the container corresponding to the number of sub-compositions and one of the respective sub-compositions being present in each of the chambers. The chambers either are configured separately and joined to one another, or are configured integrally with one another. Each of the chambers possesses at least one, in particular exactly one, outlet out of which the sub-composition can emerge from the respective chamber. This can be accomplished by the action of gravity, i.e. tilting the multi-chamber container so that the sub-compositions of the liquid washing agent composition flow out. In a further embodiment of the invention, the multi-chamber container is compressible so that the outward flow of the sub-compositions can be accelerated by a pressure exerted, for example, by a user's hand, on the multi-chamber container. If desired, the chambers can also be provided with pump apparatuses that, in the simplest case, can comprise a tubular element extending from just above the bottom of the chamber to its outlet. The outlet of the respective chamber can be embodied as a simple opening, it can be provided with pouring spouts, or it can also encompass, for example, a discharge nozzle or spray nozzle. The outlet of a liquid washing agent receptacle is usually equipped with a closure cap; in the case of the present invention, the outlet of each chamber can be equipped with its own closure cap, or the closure cap can be embodied so that it can close off several of, in particular all, the outlets of the multi-chamber container. To facilitate handling by the user, the multi-chamber container can comprise grip recesses or handles; the handle can be attached to one or several chambers or can also be part of a chamber, or several chambers each comprise a handle and are fitted to one another so that the multi-chamber container can be grasped by the user's hand. The effect of the multi-chamber container is that the sub-compositions of the liquid washing agent composition do not mix with one another until after leaving the outlets, for example when poured into a usual dispenser of a washing machine or a dispensing apparatus that is also to be introduced into the washing drum of such a washing machine, or when the agent is sprayed onto a textile surface requiring cleaning, for example in the context of laundry pretreatment. In the context of the last-mentioned spraying embodiment, it is preferred for the chambers of the multi-chamber container each to have at least one, preferably exactly one, discharge nozzle; and for the nozzle conduits of the discharge nozzles to be oriented substantially parallel to one another, but for each to comprise a cross-sectional constriction arranged asymmetrically with respect to the overall flow cross section. The cross-sectional constrictions are preferably arranged on the mutually facing sides of the nozzle conduits in such a way that the sub-compositions emerging under pressure exhibit a swirl directed toward one another. This means that as a result of the ingenious configuration of the discharge nozzles, the streams of the sub-compositions emerging from the discharge nozzles flow toward one another, as it were, in curved fashion, and encounter one another at a distance from the discharge nozzles that varies somewhat depending on the outflow pressure. The application field of the application region can then be located there, for example a stain on a piece of laundry. The multi-chamber container can be made of a material having recovery characteristics and/or can exhibit a conformation that promotes recovery to the original shape. It is particularly advisable to produce the multi-chamber container from a plastic material that recovers elastically. The material from which the multi-chamber container is shaped can be, for example, a polyolefin, in particular polypropylene (PP), polyethylene (PE), polyvinyl chloride (PVC), or polyethylene terephthalate, in particular glycol-modified polyethylene terephthalate (PETG). If desired, the material can also be mono- or polychromatic; the individual chambers of the multi-chamber container can have the same color or colors, or can have colors different from one another. Multi-chamber containers are known, for example, from International Patent Applications WO 02/22467 A1, WO 97/23087 A1, WO 96/12648 A1, WO 95/16023 A1, WO 91/04923, German Patent Application DE 32 20 693 A1, German Utility Model DE G 93 16 583 U1, or Netherlands Patent NL 1 018 746.

The liquid washing agent composition according to the present invention contains no bleach activator.

The first sub-composition preferably comprises substantially water and the organic peracid, which can be dissolved in water but in particularly preferred fashion is present at least partially undissolved, in finely particulate form. The first sub-composition can moreover also contain the organic acid corresponding to the organic peracid, as well as small quantities of usual stabilizers for the peracid, for example the vinyl ether/maleic acid copolymers known from European Patent Application EP 1 074 607 as dispersing agents, and/or the nonionic surfactants known from European Patent EP 0 497 337, and/or complexing agents that counteract metal-catalyzed decomposition of the peracid. The content of organic peracid is preferably 1 wt % to 25 wt %, in particular 2 wt % to 20 wt %, and particularly preferably 3% to 15 wt %, in each case relative to the first sub-composition. The organic peracid can carry aliphatic and/or cyclic, including heterocyclic and/or aromatic, radicals. Suitable, for example, are peroxyformic acid, peroxyacetic acid, peroxypropionic acid, peroxyhexanoic acid, peroxybenzoic acid, and their substituted derivatives such as m-chloroperoxybenzoic acid, the mono- or diperoxyphthalic acids, 1,12-diperoxydodecanoic acid, nonylamidoperoxyadipic acid, 6-hydroxyperoxyhexanoic acid, 4-phthalimidoperoxybutanoic acid, 5-phthalimidoperoxypentanoic, 6-phthalimidoperoxyhexanoic acid, 7-phthalimidoperoxyheptanoic acid, N,N′-terephthaloyl-di-6-aminoperoxyhexanoic acid, and mixtures thereof. The preferred peracids include 6-phthalimidoperoxyhexanoic acid. The first sub-composition preferably has an acid pH, in particular in the range from pH 1.5 to pH 5, and particularly preferably from pH 2.5 to pH 4.5, which results from the presence of the organic peracid or can be adjusted by the addition of system-compatible acids. The first sub-composition contains no hydrogen peroxide. This is to be understood to mean that it contains, at most, the small quantity of hydrogen peroxide that may possibly occur by hydrolysis of the organic peracid. In one embodiment of the invention, the first sub-composition can, if desired, contain anionic surfactant compatible with the organic peracid, in quantities of up to 50 wt %, in particular 10 wt % to 30 wt %, in each case relative to the first sub-composition.

The second sub-composition, or each of the further sub-compositions if applicable, contains at least one enzyme, is free of oxidatively acting bleaching agents, and preferably also comprises surfactant, in particular anionic and/or nonionic surfactant. Mixtures of nonionic and anionic surfactant are particularly preferred in this context; the second sub-composition, or each of the further sub-compositions if applicable, can contain a mixture of nonionic and anionic surfactant, or at least the second sub-composition can contain nonionic surfactant and at least one further sub-composition can contain anionic surfactant. Similarly, enzyme mixtures can be contained in the sub-compositions, or several enzymes can be distributed among the second and the further sub-compositions in such a way that each of them contains only one enzyme. Preferred are firstly mixtures of protease, amylase, lipase, and mannanase, secondly mixtures of amylase, lipase, and mannanase, thirdly mixtures of amylase and lipase, and fourthly mixtures of protease and lipase, in which context such mixtures, or at least two of the mixture constituents, can be contained together in one sub-composition, or they are distributed correspondingly among several sub-compositions, of which each comprises only one mixture constituent. The second or at least one of the further sub-compositions can be alkaline, so that after pouring out of the multi-chamber container, i.e. upon combination of all the sub-compositions, a preparation results that has a pH of preferably 4.5 to 10, in particular 5 to 9. The second sub-composition preferably contains 8 wt % to 70 wt %, in particular 20 wt % to 55 wt %, water.

The surfactants contained, if applicable, in the second sub-composition or the further sub-compositions include, in particular, anionic surfactants and nonionic surfactants, although cationic surfactants and amphoteric surfactants may also be suitable.

One or more substances from the group of the carboxylic acids, sulfuric acid semi-esters, and the sulfonic acids, preferably from the group of the fatty acids, fatty alkylsulfuric acids, and alkylarylsulfonic acids, are preferably used as the anionic surfactants. In order to exhibit sufficient surface-active properties, the aforesaid compounds should possess longer-chain hydrocarbon radicals, i.e. should comprise at least 6 carbon atoms in the alkyl or alkenyl radical. The carbon chain distributions of the anionic surfactants are usually in the range from 6 to 40, preferably 8 to 30, and in particularly 12 to 22 carbon atoms.

Carboxylic acids that are used, in the form of their alkali metal salts, as soaps in washing and cleaning agents are for the most part obtained industrially from native fats and oils by hydrolysis. While alkaline saponification, already performed in the previous century, resulted directly in the alkali salts (soaps), today only water, which cleaves the fats into glycerol and the free fatty acids, is used on an industrial scale for cleavage. Methods used on an industrial scale are, for example, cleavage in an autoclave or continuous high-pressure cleavage. Carboxylic acids usable in the context of the present invention as anionic surfactant in acid form are, for example, hexanoic acid (caproic acid), heptanoic acid (oenanthic acid), octanoic acid (caprylic acid), nonanoic acid (pelargonic acid), decanoic acid (n-capric acid), undecanoic acid, etc. The use of fatty acids such as dodecanoic acid (lauric acid), tetradecanoic acid (myristic acid), hexadecanoic acid (palmitic acid), octadecanoic acid (stearic acid), eicosanoic acid (arachidic acid), docosanoic acid (behenic acid), tetracosanoic acid (lignoceric acid), hexacosanoic acid (cerotinic acid), triacontanoic acid (melissic acid), and the unsaturated species 9c-hexadecenoic acid (palmitoleic acid), 6c-octadecenoic acid (petroselic acid), 6t-octadecenoic acid (petroselic acid), 9c-octadecenoic acid (oleic acid), 9t-octadecadienoic acid (elaidic acid), 9c,12c-octadecadienic acid (linoleic acid), 9t,12t-octadecadienic acid (linolaidic acid), and 9c,12c,15c-octadecatrienic acid (linolenic acid), is preferred in the context of the present invention. For cost reasons, it is preferred to use not the pure species but instead industrial mixtures of the individual acids as made available from fat cleavage. Such mixtures are, for example, coconut oil fatty acid (approx. 6 wt % C₈, 6 wt % C₁₀, 48 wt % C₁₂, 18 wt % C₁₄, 10 wt % C₁₆, 2 wt % C₁₈, 8 wt % C_{18′}, 1 wt % C_{18″}), palm kernel oil fatty acid (approx. 4 wt % C₈, 5 wt % C₁₀, 50 wt % C₁₂, 15 wt % C₁₄, 7 wt % C₁₆, 2 wt % C₁₈, 15 wt % C_{18′}, 1 wt % C_{18″}), tallow fatty acid (approx. 3 wt % C₁₄, 26 wt % C₁₆, 2 wt % C_{16′}, 2 wt % C₁₇, 17 wt % C₁₈, 44 wt % C_{18′}, 3 wt % C_{18″}, 1 wt % C_{18′″}), hardened tallow fatty acid (approx. 2 wt % C₁₄, 28 wt % C₁₆, 2 wt % C₁₇, 63 wt % C₁₈, 1 wt % C_{18′}), industrial oleic acid (approx. 1 wt % C₁₂, 3 wt % C₁₄, 5 wt % C₁₆, 6 wt % C_{16′}, 1 wt % C₁₇, 2 wt % C₁₈, 70 wt % C_{18′}, 10 wt % C_{18″}, 0.5 wt % C_{18′″}), industrial palmitic/stearic acid (approx. 1 wt % C₁₂, 2 wt % C₁₄, 45 wt % C₁₆, 2 wt % C₁₇, 47 wt % C₁₈, 1 wt % C_{18′}), and soybean oil fatty acid (approx. 2 wt % C₁₄, 15 wt % C₁₆, 5 wt % C₁₈, 25 wt % C_{18′}, 45 wt % C_{18″}, 7 wt % C_{18′″}).

Sulfuric acid semi-esters of longer-chain alcohols are also anionic surfactants and usable in the context of the present invention. Their alkali metal salts, in particular sodium salts, the so-called fatty alcohol sulfates, are accessible industrially from fatty alcohols, which are converted with sulfuric acid, chlorosulfonic acid, amidosulfonic acid, or sulfur trioxide to the relevant alkylsulfuric acids, and then neutralized. The fatty alcohols are obtained from the relevant fatty acids or fatty acid mixtures by high-pressure hydrogenation of the fatty acid methyl esters. The quantitatively most significant industrial process for producing fatty alkylsulfuric acids is sulfonation of the alcohols with SO₃/air mixtures in special cascade, falling-film, or tube-bundle reactors.

A further class of anionic surfactants that can be used according to the present invention are the alkyl ether sulfuric acids, whose salts, the so-called alkyl ether sulfates, are characterized by comparison with the alkyl sulfates by greater water solubility and a lower sensitivity to water hardness (solubility of Ca salts). Alkyl ether sulfuric acids, like the alkyl sulfuric acids, are synthesized from fatty alcohols that are converted with ethylene oxide to the relevant fatty alcohol ethoxylates. Propylene oxide can also be used instead of ethylene oxide. Subsequent sulfonation with gaseous sulfur trioxide in short-term sulfonation reactors provides yields of more than 98% of the relevant alkyl ether sulfuric acids.

Alkanesulfonic acids and olefinsulfonic acids are also usable in the context of the present invention as anionic surfactants in acid form. Alkanesulfonic acids can contain the sulfonic acid group in terminally bound form (primary alkanesulfonic acids) or along the carbon chain (secondary alkanesulfonic acids); only the secondary alkanesulfonic acids have commercial significance. The latter are produced by sulfochlorination or sulfoxidation of linear hydrocarbons. In sulfochlorination according to Reed, n-alkanes are converted, with sulfur dioxide and chlorine under UV light irradiation, to the corresponding sulfochlorides, which yield the alkanesulfonates directly upon hydrolysis with alkalis, and the alkanesulfonic acids upon reaction with water. Because di- and polysulfochlorides as well as chlorinated hydrocarbons can occur as byproducts of the radical reaction during sulfochlorination, the reaction is usually performed only to conversion rates of 30%, and then discontinued.

Another process for producing alkanesulfonic acids is sulfoxidation, in which n-alkanes are reacted with sulfur dioxide and oxygen under UV light irradiation. This radical reaction produces successive alkylsulfonyl radicals that react further with oxygen to form the alkylpersulfonyl radicals. Reaction with the unconverted alkane yields an alkyl radical and the alkylpersulfonic acid, which decomposes into an alkylperoxysulfonyl radical and a hydroxyl radical. Reaction of the two radicals with unconverted alkane yield the alkylsulfonic acids and water, which reacts with alkylpersulfonic acid and sulfur dioxide to form sulfuric acid. To maximize the yield of the two end products alkylsulfonic acid and sulfuric acid, and to suppress secondary reactions, this reaction is usually performed only to conversion rates of 1% and then discontinued.

Olefinsulfonates are produced industrially by reacting α-olefins with sulfur trioxide. This forms, as intermediates, zwitterions that cyclize to form so-called sultones. Under suitable conditions (alkaline or acid hydrolysis), these sultones react to form hydroxyl alkanesulfonic acids or alkenesulfonic acids, which both can likewise be used as anionic surfactant acids.

Alkyl benzenesulfonates have been known as high-performance anionic surfactants since the 1930s. At that time, alkyl benzenes were produced by monochlorination of Kogasin fractions and subsequent Friedel-Crafts alkylation, then sulfonated with oleum and neutralized with sodium hydroxide. In the early 1950s alkyl benzenesulfonates were produced by tetramerizing propylene to yield branched α-dodecylene, and the product was converted via a Friedel-Crafts reaction, using aluminum trichloride or hydrogen fluoride, to tetrapropylene benzene, which was then sulfonated and neutralized. This economical capability for producing tetrapropylene benzenesulfonates (TPS) led to a breakthrough for this surfactant class, which subsequently displaced the soaps as the main surfactant in washing and cleaning agents.

Because of the insufficient biodegradability of TPS, the need existed to present new alkyl benzenesulfonates that were characterized by better environmental behavior. This requirement was met by linear alkyl benzenesulfonates, which today are almost the only alkyl benzenesulfonates produced, and are abbreviated ABS or LAS.

Linear alkyl benzenesulfonates are produced from linear alkyl benzenes that in turn are accessible from linear olefins. This is done on an industrial scale by separating petroleum fractions with molecular sieves into the n-alkanes of the desired purity, and dehydrogenating them to yield the n-olefins, resulting in both α- and i-olefins. The olefins that are obtained are then converted with benzene, in the presence of acid catalysts, into the alkyl benzenes. The Friedel-Crafts catalyst that is selected has an influence on the isomer distribution of the resulting linear alkyl benzenes: if aluminum trichloride is used, the concentration of the 2-phenyl isomers in the mixture with the 3-, 4-, 5-, and other isomers is about 30 wt %; if hydrogen fluoride is used as the catalyst, however, the 2-phenyl isomer content can decrease to approx. 20 wt %. Lastly, sulfonation of the linear alkyl benzenes is performed today on an industrial scale with oleum, sulfuric acid, or gaseous sulfur trioxide, the latter being by far the most important. Special film or tube-bundle reactors are used for sulfonation, yielding as product a 97 wt % alkyl benzenesulfonic acid (ABSA).

By selecting the neutralizing agent, a very wide variety of salts (i.e. alkyl benzensulfonates) can be obtained from ABSA. For reasons of economy, it is preferred in this context to produce and use the alkali metal salts, and of those preferably the sodium salts, of ABSA. These can be described by the general formula below: 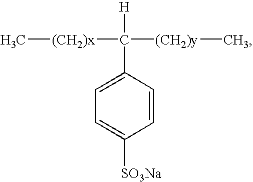
in which the sum of x and y is usually between 5 and 13. C₈₋₁₆, preferably C₉₋₁₃ alkyl benzenesulfonic acids are preferred according to the present invention as anionic surfactant in acid form. It is further preferred in the context of the present invention to use C₈₋₁₆, preferably C₉₋₁₃ alkyl benzenesulfonic acids that are derived from alkyl benzenes which have a tetralin content of less than 5 wt % relative to the alkyl benzene. It is further preferred to use alkyl benzenesulfonates whose alkyl benzenes were produced according to the HF method, so that the C₈₋₁₆, preferably C₉₋₁₃ alkyl benzenesulfonic acids used have a 2-phenyl isomer content of less than 22 wt % relative to the alkyl benzensulfonic acid.

The aforementioned anionic surfactants can be used alone or in a mixture with one another, mixtures of fatty acids and ether sulfates, in particular at weight ratios of 5:1 to 1:5, preferably 2:1 to 1:2, being particularly preferred. The anionic surfactants described above in their acid form are usually used in partially or completely neutralized form. Suitable cations for the anionic surfactants, in addition to the alkali metals (here in particular Na and K salts) are ammonium as well as mono-, di-, or triethanolammonium ions. Instead of mono-, di-, or triethanolamines, the analogous representatives of mono-, di-, or trimethanolamine, or those of the alkanolamines or higher alcohols, can be quaternized and added as the cation.

The nonionic surfactants used are preferably alkoxylated, advantageously ethoxylated, in particular primary alcohols preferably having 8 to 18 carbon atoms and an average of 1 to 12 mol ethylene oxide (EO) per mol of alcohol, in which the alcohol radical can be linear or preferably methyl-branched in the 2- position, or can contain linear or methyl-branched radicals in the mixture, such as those usually present in oxo alcohol radicals. Particularly preferred, however, are alcohol ethoxylates having linear radicals made up of alcohols of natural origin having 12 to 18 carbon atoms, e.g. from coconut, palm, tallow, or oleyl alcohol, and an average of 2 to 8 EO per mol of alcohol. The preferred ethoxylated alcohols include, for example C₁₂₋₁₄ alcohols having 3 EO or 4 EO, C₉₋₁₁ alcohols having 7 EO, C₁₃₋₁₅ alcohols having 3 EO, 5 EO, 7 EO, or 8 EO, C₁₂₋₁₈ alcohols having 3 EO, 5 EO, or 7 EO, and mixtures thereof, such as mixtures of C₁₂₋₁₄ alcohol having 3 EO and C₁₂₋₁₈ alcohol having 5 EO. The degrees of ethoxylation that are indicated represent statistical averages, which for a specific product may be a whole or fractional number. Preferred alcohol ethyoxylates exhibit a restricted homologue distribution (=narrow range ethoxylates, NRE). In addition to these nonionic surfactants, fatty alcohols having more than 12 EO can also be used. Examples of these are tallow alcohol having 14 EO, 25 EO, 30 EO, or 40 EO. Low-foaming nonionic surfactants that have alternating ethylene oxide and alkylene oxide units can also be used. Preferred among these, in turn, are surfactants having EO-AO-EO-AO blocks, one to ten EO and AO groups being bound to one another in each case before a block of the respectively other group then follows. Examples of this are surfactants of the general formula 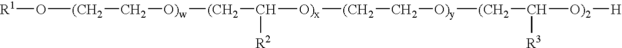
in which R¹ denotes a straight-chain or branched, saturated or mono- or polyunsaturated C₆₋₂₄ alkyl or alkylene radical; each R² and R³ group, independently of one another, is selected from —CH₃, —CH₂CH₃, —CH₂CH₂—CH₃, CH(CH₃)₂; and the indices w, x, y, z denote, independently of one another, whole numbers from 1 to 6. These can be produced, using known methods, from the corresponding alcohols R¹—OH and ethylene oxide or alkylene oxide. The R¹ radical in the formula above can vary depending on the provenience of the alcohol. If natural sources are used, the R¹ radical has an even number of carbon atoms and is generally unbranched, the linear radicals from natural-origin alcohols having 12 to 18 carbon atoms, e.g. from coconut, palm, tallow, or oleyl alcohol, being preferred. Alcohols accessible from synthetic sources are, for example, the Guerbet alcohols or radicals methyl-branched in the 2- position, or mixed linear and methyl-branched radicals, such as those usually present in oxo alcohol radicals. Regardless of the type of alcohol used to produce the nonionic surfactants contained according to the present invention in the agents, agents according to the present invention in which R¹ in the above formula denotes an alkyl radical having 6 to 24, preferably 8 to 20, particularly preferably 9 to 15 and in particular 9 to 11 carbon atoms are preferred. In addition to propylene oxide, butylene oxide in particular is possible as the alkylene oxide unit that can be contained in the nonionic surfactants alternatingly with the ethylene oxide unit. Also suitable, however, are further alkylene oxides in which R² and R³ are selected, independently of one another, from —CH₂CH₂—CH₃ and CH(CH₃)₂.

It is additionally possible to use as nonionic surfactants alkyl glycosides having the general formula RO(Gₓ), in which R denotes a primary straight-chain or methyl-branched aliphatic radical, in particular one methyl-branched in the 2- position, having 8 to 22, preferably 12 to 18 carbon atoms; and G denotes a glycose unit having 5 or 6 carbon atoms, preferably glucose. The degree of oligomerization x that indicates the distribution of monoglycosides and oligoglycosides is any number between 1 and 10; x is preferably between 1.2 and 1.4.

A further class of nonionic surfactants that are preferred for use, which can be used either as the only nonionic surfactant or in combination with other nonionic surfactants, are alkoxylated, preferably ethyoxylated or ethoxylated and propoxylated, fatty acid alkyl esters preferably having 1 to 4 carbon atoms in the alkyl chain, in particular fatty acid methyl esters.

Nonionic surfactants of the amine oxide type, for example N-cocalkyl-N,N-dimethylamine oxide and N-tallowalkyl-N,N-dihydroxyethylamine oxide, and the fatty acid alkanolamides, can also be suitable.

Further suitable surfactants are polyhydroxy fatty acid amides having the following formula: 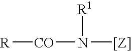
in which RCO denotes an aliphatic acyl radical having 6 to 22 carbon atoms, R¹ denotes hydrogen or an alkyl or hydroxyalkyl radical having 1 to 4 carbon atoms, and [Z] denotes a linear or branched polyhydroxyalkyl radical having 3 to 10 carbon atoms and 3 to 10 hydroxyl groups. The polyhydroxy fatty acid amides are known substances that can usually be obtained by reductive amination of a reducing sugar using ammonia, an alkylamine, or an alkanolamine, and subsequent acylation using a fatty acid, a fatty acid alkyl ester, or a fatty acid chloride.

The group of the polyhydroxy fatty acid amides also includes compounds having the formula 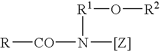
in which R denotes a linear or branched alkyl or alkenyl radical having 7 to 12 carbon atoms; R¹ a linear, branched, or cyclic alkyl radical or an aryl radical having 2 to 8 carbon atoms; and R² a linear, branched, or cyclic alkyl radical or an aryl radical or an oxyalkyl radical having 1 to 8 carbon atoms, C₁₋₄ alkyl or phenyl radicals being preferred; and [Z] denotes a linear polyhydroxyalkyl radical whose alkyl chain is substituted with at least two hydroxyl groups, or alkoxylated, preferably ethoxylated or propoxylated, derivatives of that radical.

[Z] is preferably obtained by reductive amination of a reduced sugar, for example glucose, fructose, maltose, lactose, galactose, mannose, or xylose. The N-alkoxy- or N-aryloxy-substituted compounds can then be converted to the desired polyhydroxy fatty acid amides by reaction with fatty acid methyl esters in the presence of an alkoxide as catalyst.

Additional usable nonionic surfactants are the linear poly(oxyalkylated) surfactants having the formula
R¹O[CH₂CH(R³)O]ₓ[CH₂]ₖCH(OH)[CH₂]ⱼOR²
in which R¹ and R² denote linear or branched, saturated or unsaturated, aliphatic or aromatic hydrocarbon radicals having 1 to 30 carbon atoms; R³ denotes H or a methyl, ethyl, n-propyl, isopropyl, n-butyl, 2-butyl, or 2-methyl-2-butyl radical; x denotes values between 1 and 30; k and j values between 1 and 12, preferably between 1 and 5. If the value of x≧2, each R³ in the formula above can be different. R¹ and R² are preferably linear or branched, saturated or unsaturated, aliphatic or aromatic hydrocarbon radicals having 6 to 22 carbon atoms, radicals having 8 to 18 carbon atoms being particularly preferred. For the R³ radical, H, —CH₃, or —CH₂CH₃ are particularly preferred. Particularly preferred values for x are in the range from 1 to 20, in particular from 6 to 15.

Among the nonionic surfactants, mixtures of alkoxylated fatty alcohols and alkyl glycosides in which the weight ratio between them is preferably 10:1 to 1:2, in particular 10:1 to 2:1, are preferred.

It is particularly preferred if the weight ratio of anionic surfactant to nonionic surfactant is between 10:1 and 1:10, preferably between 7.5:1 and 1:5, and in particular between 5:1 and 1:2. It is preferred if surfactant is present in quantities from 5 wt % to 80 wt %, preferably from 7.5 wt % to 70 wt %, particularly preferably from 10 wt % to 60 wt %, and in particular from 12.5 wt % to 50 wt %. The quantities and ratios indicated refer in one embodiment of the invention to the individual (second or further) sub-compositions, and in a further embodiment to the entire agent according to the present invention.

The enzymes contained in the second sub-composition or the further sub-compositions include, in particular, protease, amylase, lipase, cellulase, and/or hemicellulase such as mannanase. These enzymes are, in principle, of natural origin; proceeding from the natural molecules, improved variants are available for use in washing and cleaning agents and are correspondingly used in preferred fashion. Agents according to the present invention contain, in the second sub-composition or the further sub-compositions, enzymes preferably in total quantities of 1×10⁻⁶ to 5 wt %, in terms of the active protein. The protein concentration can be determined using known methods, for example the BCA method (bicinchoninic acid; 2,2′-biquinolyl-4,4′-dicarboxylic acid) or the biuret method (A. G. Gornall, C. S. Bardawill, and M. M. David, J. Biol. Chem. 177 (1948), pp. 751-766). The first sub-composition is free of enzymes. In a preferred embodiment of agents according to the present invention, the second sub-composition contains protease, amylase, and cellulase. In this case further sub-compositions (i.e. other than the first one) can be entirely absent.

Among the proteases, those of the subtilisin type are preferred. Example of these are subtilisins BPN′ and Carlsberg, protease PB92, subtilisins 147 and 309, the alkaline protease from Bacillus lentus, subtilisin DY, and the enzymes (to be classified, however, as subtilases rather than subtilisins in the narrower sense) thermitase, proteinase K, and proteases TW3 and TW7. Subtilisin Carlsberg is available in further developed form, under the trade name Alcalase®, from Novozymes A/S, Bagsvaerd, Denmark. Subtilisins 147 and 309 are marketed by Novozymes under the trade names Esperase® and Savinase®, respectively. Derived from the protease DSM 5483 from Bacillus lentus (known from International Patent Application WO 91/02792) are the variants, listed under the designation BLAP®, that are described in particular in International Patent Applications WO 92/21760, WO 95/23221 and German Patent Applications DE 101 21 463 and DE 101 53 792. Additionally usable proteases from various Bacillus sp. and B. gibsonii are indicated by German Patent Applications DE 101 62 727, DE 101 63 883, DE 101 63 884, and DE 101 62 728. Further usable proteases are, for example, the enzymes obtainable from Novozymes under the trade names Durazym®, Relase®, Everlase®, Nafizym®, Natalase®, Kannase®, and Ovozymes®, from Genencor under the trade names Purafect®, Purafect® OxP, and Properase®, from Advanced Biochemicals Ltd., Thane, India under the trade name Protosol®, from Wuxi Snyder Bioproducts Ltd., China under the trade name Wuxi®, from Amano Pharmaceuticals Ltd., Nagoya, Japan under the trade names Proleather® and Protease P®, and from Kao Corp., Tokyo, Japan under the name Proteinase K-16.

Examples of amylases that can be used according to the present invention are the α-amylases from Bacillus licheniformis, from B. amyloliquefaciens, or from B. stearothermophilus, as well as their developments improved for use in washing and cleaning agents. The enzyme from B. licheniformis is available from Novozymes under the name Termamyl®, and from Genencor under the name Purastar® ST. Development products of these α-amylases are obtainable from Novozymes under the trade names Duramyl® and Termamyl® ultra, from Genencor under the name Purastar® OxAm, and from Daiwa Seiko Inc., Tokyo, Japan as Keistase®. The α-amylase of B. amyloliquefaciens is marketed by Novozymes under the name BAN®, as are derived variants of the α-amylase from B. stearothermophilus under the names BSG® and Novamyl®, likewise from Novozymes. Additionally to be emphasized are the α-amylase from Bacillus sp. A 7-7 (DSM 12368) disclosed in International Patent Application WO 02/10356 and the cyclodextrin glucanotransferase (CGTase) from B. agaradherens (DSM 9948) described in International Patent Application PCT/EP01/13278; also those belonging to the sequence space of α-amylases that are defined in German Patent Application DE 101 31 441. Also usable are fusion products of the aforesaid molecules, for example those known from German Patent Application DE 101 38 753. The developments of α-amylase from Aspergillus niger and A. oryzae obtainable from Novozymes under the trade names Fungamyl® are additionally suitable. A further commercial product is, for example, Amylase-LT®.

Agents according to the present invention can contain lipases and/or cutinases. These include, for example, the lipases originally obtained or further developed from Humicola lanuginosa (Thermomyces lanuginosus), in particular those with the amino acid exchange D96L. These are marketed, for example, by Novozymes under the trade names Lipolase®, Lipolase® Ultra, LipoPrime®, Lipozyme®, and Lipex®. Additionally usable are, for example, the cutinases that were originally isolated from Fusarium solani pisi and Humicola insolens. Usable lipases are likewise obtainable from Amano under the designations Lipase CE®, Lipase P®, Lipase B®, and Lipase CES®, Lipase AKG®, Bacillis sp. Lipase®, Lipase AP®, Lipase M-AP®, and Lipase AML®. Lipases and cutinases from Genencor whose starting enzymes were originally isolated respectively from Pseudomonas mendocina and Fusarium solanii are, for example, usable. Additional important commercial products that may be mentioned are the preparations M1 Lipase® and Lipomax® originally marketed by Gist-Brocades, and the enzymes marketed by Meito Sangyo KK, Japan under the names Lipase MY-30®, Lipase OF®, and Lipase PL®, also the Lumafast® product from Genencor.

Agents according to the present invention can contain cellulases, depending on the purpose either as pure enzymes, as enzyme preparations, or in the form of mixtures in which the individual components advantageously complement one another in terms of their various performance aspects. These performance aspects include, in particular, contributions to primary washing performance, to the secondary washing performance of the agent (anti-redeposition effect or graying inhibition), and avivage (textile effect), and even the production of “stone-washed” effects. A usable fungus-derived endoglucanase (EG)-rich cellulase preparation, and its developments, are offered by Novozymes under the trade name Celluzyme®. The Endolase® and Carezyme® products, likewise obtainable from Novozymes, are based on the 50 kD EG and 43 kD EG, respectively, from H. insolens DSM 1800. Additional commercial products from this company are Cellusoft® and Renozyme®. Also usable are the cellulases disclosed in International Patent Application WO 97/14804, for example the 20 kD EG from Melanocarpus disclosed therein that is obtainable from AB Enzymes, Finland, under the trade names Ecostone® and Biotouch®. Further commercial products of AB Enzymes are Econase® and Ecopulp®. Further suitable cellulases from Bacillus sp CBS 670.93 and CBS 669.93 are disclosed in International Patent Application WO 96/34092, the one from Bacillus sp. CBS 670.93 being available from Genencor under the trade name Puradax®. Further commercial products of Genencor are “Genencor detergent cellulase L” and IndiAge® Neutra.

Agents according to the present invention can contain further enzymes that are grouped under the term “hemicellulases.” These include, for example, mannanases, xanthan lyases, pectin lyases (=pectinases), pectin esterases, pectate lyases, xyloglucanases (=xylanases), pullulanases, and β-glucanases. Suitable mannanases are obtained, for example, from Novozymes under the names Gamanase® and Pektinex AR®, from AB Enzymes under the name Rohapec® B1L, and from Diversa Corp., San Diego, Calif., USA under the name Pyrolase®. A suitable β-glucanase from a B. alcalophilus is described, for example, in International Patent Application WO 99/06573. The β-glucanase obtained from B. subtilis is available from Novozymes under the name Cereflo®.

The enzymes used in agents according to the present invention either derive originally from microorganisms, for example the genera Bacillus, Streptomyces, Humicola, or Pseudomonas, and/or are produced by suitable microorganisms according to biotechnological methods known per se, for example by means of transgenic expression hosts of the Bacillus genera, or filamentous fungi.

An enzyme contained in an agent according to the present invention can be protected, especially during storage, from damage such as, for example, inactivation, denaturing, or decomposition caused, for example, by physical influences, oxidation, or proteolytic cleavage. Agents according to the present invention can contain enzyme stabilizers for this purpose. One group of enzyme stabilizers are reversible protease inhibitors. Benzamidine hydrochloride, borax, boric acids, boronic acids, or their salts or esters are often used, among them principally derivatives having aromatic groups, for example ortho-substituted (according to International Patent Application WO 95/12655), meta-substituted (according to International Patent Application WO 92/19707), and para-substituted (according to U.S. Pat. No. 5,972,873) phenylboronic acids or their salts or esters. Peptide aldehydes, i.e. oligopeptides having a reduced carbon terminus, are disclosed for the same purpose in International Patent Application WO 98/13460 and European Patent Application EP 583 534. Among the peptidic protease inhibitors to be mentioned are ovomucoid (according to International Patent Application WO 93/00418) and leupeptin; an additional option is the creation of fusion proteins from proteases and peptide inhibitors. Further enzyme stabilizers are amino alcohols such as mono-, di-, triethanolamine and -propanolamine and their mixtures, aliphatic carboxylic acids up to C₁₂, known for example from European Patent Application EP 0 378 261 or International Patent Application WO 97/05227, such as succinic acid, other dicarboxylic acids, or salts of the aforesaid acids. German Patent Application DE 196 50 537 discloses linear fatty acid amide alkoxylates for this purpose. Certain organic acids used as builders make it possible, as disclosed in International Patent Application WO 97/18287, additionally to stabilize an enzyme that is present. Lower aliphatic alcohols such as ethanol or propanol, but principally polyols such as, for example, glycerol, ethylene glycol, propylene glycol, or sorbitol, are further usable enzyme stabilizers. According to European Patent Application EP 0 965 268, diglycerol phosphate also protects against denaturing due to physical influences. Calcium salts are also often used, for example calcium acetate or the calcium formate disclosed for this purpose in European Patent EP 0 028 865, as are magnesium salts, for example according to European Patent Application EP 0 387 262. Reducing agents and antioxidants enhance the stability of enzymes with respect to oxidative decomposition, as disclosed inter alia in European Patent Application EP 0 780 466. Sulfur-containing reducing agents are known, for example, from European Patents EP 0 080 748 and EP 0 080 223. Other examples thereof are sodium sulfite (according to European Patent Application EP 0 533 239) and reducing sugars (according to European Patent Application EP 0 656 058).

Preferably combinations of stabilizers are used, for example made up of polyols, boric acid, and/or borax according to International Patent Application WO 96/31589, the combination of boric acid or borate, reducing salts, and succinic acid or other dicarboxylic acids according to European Patent Application EP 0 126 505, or the combination of boric acid or borate with polyols or polyamino compounds and with reducing salts, as disclosed in European Patent Application EP 0 080 223. The effect of peptide-aldehyde stabilizers is, according to International Patent Application WO 98/13462, enhanced by the combination with boric acid and/or boric acid derivatives and polyols, and according to International Patent Application WO 98/13459 is further reinforced by the additional use of divalent cations such as, for example, calcium ions.

The second sub-composition or the further sub-compositions can furthermore comprise all ingredients common in liquid washing agents that can reasonably be expected not to interact negatively with the known ingredients. These include, for example, builder materials, complexing agents for heavy metals, nonaqueous water-miscible solvents, thickening agents, graying inhibitors, foam regulators, color transfer inhibitors, antimicrobial ingredients, optical brighteners, dyes, and fragrances. If desired, such further ingredients can also be contained in the first sub-composition if they can be expected not to impair the storage stability of the peracid component.

Silicates, aluminum silicates (especially zeolites), carbonates, salts of organic di- and polycarboxylic acids, and mixtures of these substances may be mentioned as builder materials that can be contained in the agents according to the present invention.

Suitable crystalline, layered sodium silicates possess the general formula NaMSiₓO₂ₓ₊₁.yH₂O, where M denotes sodium or hydrogen, x a number from 1.9 to 4, and y is a number from 0 to 20, and preferred values for x are 2, 3, or 4. Crystalline layer silicates of this kind are described, for example, in European Patent Application EP 0 164 514. Preferred crystalline layered silicates having the formula indicated above are those in which M denotes sodium and x assumes the value 2 or 3. Both β- and δ-sodium disilicates Na₂Si₂O₅.yH₂O are particularly preferred; β-sodium disilicate can be obtained, for example, according to the method described in International Patent Application WO 91/08171.

Also usable are amorphous sodium silicates having a Na₂O:SiO₂ modulus of 1:2 to 1:3.3, preferably 1:2 to 1:2.8, and in particular 1:2 to 1:2.6, which are dissolution-delayed and exhibit secondary washing properties. Dissolution delay as compared with conventional amorphous sodium silicates can have been brought about in various ways, for example by surface treatment, compounding, compacting/densification, or overdrying. In the context of this invention, the term “amorphous” is also understood to mean “X-amorphous.” In other words, in X-ray diffraction experiments the silicates yield not the sharp X-ray reflections that are typical of crystalline substances, but instead at most one or more maxima in the scattered X radiation, having a width of several degree units of the diffraction angle. Particularly good builder properties can, however, very easily be obtained even if the silicate particles yield blurred or even sharp diffraction maxima in electron beam diffraction experiments. This may be interpreted to mean that the products have microcrystalline regions 10 to several hundred nm in size, values of up to a maximum of 50 nm, and in particular a maximum of 20 nm, being preferred. So-called X-amorphous silicates of this kind, which also exhibit a dissolution delay as compared with conventional water glasses, are described, for example, in German Patent Application DE 44 00 024. Densified/compacted amorphous silicates, compounded amorphous silicates, and overdried X-amorphous silicates are particularly preferred.

The finely crystalline synthetic zeolite containing bound water that is used if applicable is preferably zeolite A and/or zeolite P. Zeolite MAP® (commercial product of the Crosfield Co.) is particularly preferred as zeolite P. Also suitable, however, are zeolite X as well as mixtures of A, X, and/or P. Also commercially available and preferred for use in the context of the present invention is, for example, a co-crystal of zeolite X and zeolite A (approx. 80 wt % zeolite X) that is marketed by CONDEA Augusta S.p.A. under the trade name VEGOBOND AX® and can be described by the formula nNa₂O.(1-n)K₂O.Al₂O₃.(2-2.5)SiO₂.(3.5-5.5)H₂O. The zeolite can be used as a spray-dried powder or also as an undried stabilized suspension still moist as manufactured. In the event the zeolite is used as a suspension, the latter can contain small additions of nonionic surfactants as stabilizers, for example 1 to 3 wt % relative to the zeolite of ethoxylated C₁₂-C₁₈ fatty alcohols having 2 to 5 ethylene oxide groups, C₁₂-C₁₄ fatty alcohols having 4 to 5 ethylene oxide groups, or ethoxylated isotridecanols. Suitable zeolites exhibit an average particle size of less than 10 μm (volume distribution; measured e.g. with a Coulter Counter), and preferably contain 18 to 22 wt %, in particular 20 to 22 wt %, of bound water.

Use of the commonly known phosphates as builder substances is also possible, of course, provided such use is not to be avoided for environmental reasons. The sodium salts of the orthophosphates, pyrophosphates, and in particular the tripolyphosphates are particularly suitable.

Usable organic builder substances are the polycarboxylic acids, usable e.g. in the form of their sodium salts; “polycarboxylic acids” are to be understood as those carboxylic acids that carry more than one acid function. These are, for example, citric acid, adipic acid, succinic acid, glutaric acid, malic acid, tartaric acid, maleic acid, fumaric acid, sugar acids, aminocarboxylic acids, nitrilotriacetic acid (NTA), provided such use is not objectionable for environmental reasons, as well as mixtures thereof. Preferred salts are the salts of polycarboxylic acids such as citric acid, adipic acid, succinic acid, glutaric acid, tartaric acid, sugar acids, and mixtures thereof. The acids themselves can also be used. The acids typically possess not only their builder effect but also the property of an acidifying component, and thus serve also to establish a lower and milder pH in washing or cleaning agents. Particularly to be mentioned in this context are citric acid, succinic acid, glutaric acid, adipic acid, gluconic acid, and any mixtures thereof. Polymeric polycarboxylates are furthermore suitable as builders; these are, for example, the alkali metal salts of polyacrylic acid or polymethacrylic acid, for example those having a relative molecular weight of 500 to 70,000 g/mol. For purposes of this document, the molecular weights indicated for polymeric polycarboxylates are weight-averaged molecular weights Mw of the respective acid form, which can be determined in principle by gel permeation chromatography (GPC) using a UV detector. The measurement is performed against an external polyacrylic acid standard that, because of its structural kinship with the polymers being examined, provides realistic molecular weight values. These data deviate considerably from the molecular weight data when polystyrene sulfonic acids are used as the standard, the molar weights measured against polystyrene sulfonic acids usually being much higher. Suitable polymers are, in particular, polyacrylates that preferably have a molecular weight of 2000 to 20,000 g/mol. Of this group in turn, the short-chain polyacrylates having molar weights from 2000 to 10,000 g/mol, and particularly preferably from 3000 to 5000 g/mol, may be particularly preferred because of their superior solubility. Copolymeric polycarboxylates, in particular those of acrylic acid with methacrylic acid and of acrylic acid or methacrylic acid with maleic acid, are also suitable. Copolymers of acrylic acid with maleic acid containing 50 to 90 wt % acrylic acid and 50 to 10 wt % maleic acid have proven particularly suitable. Their relative molecular weight relative to free acids is generally 2000 to 70,000 g/mol, preferably 20,000 to 50,000 g/mol, and in particular 30,000 to 40,000 g/mol. To improve water solubility, the polymers can also contain allyl sulfonic acids, for example allyl oxybenzenesulfonic acid and methallyl sulfonic acid as in EP-B-0 727 448, as monomers. Also particularly preferred are biodegradable polymers made up of more than two different monomer units, for example those that, according to German Patent Application DE 43 00 772 A1, contain as monomers salts of acrylic acid and maleic acid as well as vinyl alcohol or vinyl alcohol derivatives; or that, according to German Patent DE 42 21 381, contain as monomers salts of acrylic acid and 2-alkylallyl sulfonic acid, as well as sugar derivatives. Further preferred copolymers are those that are described in German Patent Applications DE-A43 03 320 and DE-A-44 17 734 and preferably comprise acrolein and acrylic acid/acrylic acid salts, or acrolein and vinyl acetate, as monomers. Polymeric aminodicarboxylic acids, their salts, or their precursor substances may likewise be mentioned as additional preferred builder substances. Particularly preferred are polyaspartic acids and their salts and derivatives, concerning which German Patent Application DE 195 40 086 A1 discloses that they exhibit not only cobuilder properties but also a bleach-stabilizing effect. Further suitable builder substances are polyacetals that can be obtained by reacting dialdehydes with polyol carboxylic acids having 5 to 7 carbon atoms and at least three hydroxyl groups, as described e.g. in European Patent Application EP 0 280 223. Preferred polyacetals are obtained from dialdehydes such as glyoxal, glutaraldehyde, terephthalaldehyde and mixtures thereof, and from polyol carboxylic acids such as gluconic acid and/or glucoheptonic acid. Further suitable organic builder substances are dextrins, for example oligomers or polymers of carbohydrates, which can be obtained by partial hydrolysis of starches. The hydrolysis can be performed using ordinary, for example acid- or enzyme-catalyzed, methods. The hydrolysis products preferably have average molar weights in the range from 400 to 500,000 g/mol. A polysaccharide having a dextrose equivalent (DE) in the range from 0.5 to 40, in particular from 2 to 30, is preferred, DE being a common indicator of the reducing power of a polysaccharide as compared with dextrose, which possesses a DE of 100. Maltodextrins having a DE of between 3 and 20 and dry glucose syrups having a DE of between 20 and 37, as well as so-called yellow dextrins and white dextrins having higher molar weights in the range from 2000 to 30,000 g/mol, are usable. A preferred dextrin is described in European Patent Application EP 0 703 292 A1. Relevant oxidized derivatives of such dextrins are their reaction products with oxidizing agents that are capable of oxidizing at least one alcohol function of the saccharide ring to the carboxylic acid function. Oxidized dextrins of this kind, and methods for their manufacture, are known e.g. from European Patent Applications EP 0 232 202, EP 0 427 349, EP 0 472 042, and EP 0 542 496, and International Patent Applications WO 92/18542, WO 93/08251, WO 93/16110, WO 94/28030, WO 95/07303, WO 95/12619, and WO 95/20608. Also suitable is an oxidized oligosaccharide according to German Patent Application DE-A-196 00 018. A product oxidized at C₆ of the saccharide ring can be particularly advantageous. Oxydisuccinates and other derivatives of disuccinates, preferably ethylenediamine disuccinate, are additional suitable builder materials. Ethylenediamine-N,N′-disuccinate (EDDS), synthesis of which is described e.g. in U.S. Pat. No. 3,158,615, is preferably used in the form of its sodium or magnesium salts. Also preferred in this context are glycerol disuccinates and glycerol trisuccinates, such as those described e.g. in U.S. Pat. No. 4,524,009, U.S. Pat. No. 4,639,325, in European Patent Application EP-A-0 150 930, and in Japanese Patent Application JP 93/339896. Further usable organic builders are, for example, acetylated hydroxycarboxylic acids and their salts, which may optionally also be present in lactone form and which contain at least 4 carbon atoms and at least one hydroxy group, as well as a maximum of two acid groups. Builders of this kind are described, for example, in International Patent Application WO 95/20029. Builder substances, and among them in particular water-soluble materials, are contained in agents according to the present invention preferably in quantities of 1 wt % to 20 wt %, in particular 1 wt % to 8 wt %, the first sub-composition preferably being free of builder materials.

The complexing agents for heavy metals contained, if applicable, in the agents include phosphoric acid, aminocarboxylic acids, and, if applicable, functionally modified phosphonic acids, for example hydroxyphosphonic acids or aminoalkane phosphonic acids. The usable aminocarboxylic acids include, for example, nitrilotriacetic acid (NTA), methylglycine diacetic acid, and diethylenetriamine pentaacetic acid. Appropriate phosphonic acids are, for example, 1-hydroxyethane-1,1-diphosphonic acid (HEDP) and the disodium or tetrasodium salt of that acid, 2-phosphonobutane-1,2,4-tricarboxylic acid and the trisodium salt of that acid, ethylenediaminetetramethylene phosphonic aicd (EDTMP), diethylenetriaminepentamethylene phosphonic acid (DTPMP), and their higher homologues. The N-oxides corresponding to the aforesaid nitrogen-containing compounds can also be used. The usable complexing agents also include ethylenediamine-N,N′-disuccinic acid (EDDS). The complexing agents mentioned in their acid form can be used as such or in the form of their alkali salts, in particular sodium salts. It is preferred to use mixtures of aminocarboxylic acids with phosphonic acids. Complexing agents for heavy metals are contained in agents according to the present invention preferably in quantities of 0.05 wt % to 1 wt %; they can be contained, as desired, in the first sub-composition and/or in the second or further sub-compositions.

Nonaqueous solvents that can be used in the agents according to the present invention derive, for example, from the group of the univalent alcohols, alkanolamines, or glycol ethers, provided they are miscible with water in the concentration range provided for use. The solvents are preferably selected from ethanol, n- or i-propanol, the butanols, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl, ethyl, or propyl ether, dipropylene glycol monomethyl or -ethyl ether, diisopropylene glycol monomethyl or -ethyl ether, methoxy-, ethoxy-, or butoxytriglycol, 1-butoxyethoxy-2-propanol, 3-methyl-3-methyoxybutanol, propylene glycol t-butyl ether, and mixtures of these solvents. Nonaqueous solvents can be used in the liquid washing agents according to the present invention, if desired, in quantities of up to 40 wt %, preferably 0.5 to 20 wt %, and in particular 1 wt % to 10 wt %; of the aforesaid solvents, the quantities of those that also simultaneously act as enzyme stabilizers are included in the calculation.

Suitable foam inhibitors that can be used in the agents according to the present invention are, for example, soaps, alkanes, or silicone oils. Silicone oils are preferably used.

Suitable anti-redeposition agents, which are also referred to as soil repellents, are, for example, nonionic cellulose ethers such as methylcellulose and methylhydroxypropylcellulose having a 15 to 30 wt % proportion of methoxy groups and a 1 to 15 wt % proportion of hydroxypropyl groups, relative to the nonionic cellulose ethers in each case, as well as polymers, known from the existing art, of phthalic acid and/or terephthalic acid and of their derivatives, in particular polymers of ethylene terephthalates and/or polyethylene glycol terephthalates or anionically and/or nonionically modified derivatives thereof. Of these, the sulfonated derivates of phthalic acid polymers and terephthalic acid polymers are particularly preferred.

Optical brighteners can be added to the agents according to the present invention in order to eliminate graying and yellowing of the treated textiles. These substances absorb onto the fibers and cause brightening and a simulated bleaching effect by converting invisible ultraviolet radiation into longer-wave visible light, the ultraviolet light absorbed from sunlight being emitted as slightly bluish fluorescence and resulting, with the yellow tone of the grayed or yellowed laundry, in pure white. Suitable compounds derive, for example, from the substance classes of the 4,4′-diamino-2,2′-stilbenedisulfonic acids (flavonic acids), 4,4′-distyryl biphenyls, methyl umbelliferones, cumarins, dihydroquinolinones, 1,3-diarylpyrazolines, naphthalic acid imides, benzoxazole, benzisoxazole, and benzimidazole systems, and pyrene derivatives substituted with heterocycles. The optical brighteners are usually used in quantities of between 0.05 and 0.3 wt % relative to the finished agent.

The purpose of graying inhibitors is to keep dirt that has been detached from the fibers suspended in the washing bath, and thus prevent it from redepositing. Water-soluble colloids, usually organic in nature, are suitable for this, for example glue, gelatin, salts of ethersulfonic acids of starch or of cellulose, or salts of acid sulfuric acid esters of cellulose or of starch. Water-soluble polyamides containing acid groups are also suitable for this purpose. Soluble starch preparations, and starch products other than those cited above, can also be used, for example degraded starch, aldehyde starches, etc. Polyvinylpyrrolidone is also usable. Cellulose ethers such as carboxymethylcellulose (Na salt), methylcellulose, hydroxyalkylcellulose, and mixed ethers such as methylhydroxyethylcellulose, methylhydroxypropylcellulose, methylcarboxymethylcellulose, and mixtures thereof are preferred for use, however, in quantities of 0.1 to 5 wt % relative to the agent.

Because textile fabrics, in particular those made of rayon, wool, cotton, and mixtures thereof, can tend to wrinkle because the individual fibers are sensitive to bending, kinking, pressing, and squeezing transversely to the fiber direction, the agents according to the present invention can contain synthetic wrinkle-protection agents, although these are preferably not contained in the first sub-composition. These include, for example, synthetic products based on fatty acids, fatty acid esters, fatty acid amides, alkylol esters, or alkylolamides, or fatty alcohols that are usually reacted with ethylene oxide, or products based on lecithin or modified phosphoric acid esters.

To counteract microorganisms, the agents according to the present invention can contain antimicrobial active substances. A distinction is made here, in terms of the antimicrobial spectrum and mechanism of action, between bacteriostatics and bactericides, fungistatics and fungicides, etc. Important substances from these groups are, for example, benzalkonium chloride, alkylarylsulfonates, halogen phenols, and phenol mercuric acetate; these compounds can also be entirely dispensed with in the agents according to the present invention.

Thickening ingredients usable in the sub-compositions according to the present invention are, for example, those from the class of the polyurethanes, polyacrylates (which can also be present in at least partly cross-linked fashion), polyacrylamides, and/or polysaccharides, and their derivatives. Suitable as a polysaccharidic thickening ingredient, in addition to carboxylated and/or alkoxylated cellulose, is an (optionally modified) polymer made up of saccharides such as glucose, galactose, mannose, gulose, altrose, allose, etc. A water-soluble xanthan, such as the one commercially available, for example, under the product designations Kelzan®, Rhodopol®, Ketrol®, or Rheozan®, is preferably used. “Xanthan” is understood to be a polysaccharide corresponding to the one produced by the bacterial strain Xanthomonas campestris from aqueous solutions of glucose or starch (J. Biochem. Microbiol. Technol. Engineer. Vol. III (1961), pp. 51-63). It comprises substantially glucose, mannose, glucuronic acid, and their acetylation products, and furthermore contains subordinate quantities of chemically bound pyruvic acid. The use of water-soluble polysaccharide derivatives, such as those that can be obtained from the corresponding polysaccharides, for example, by oxalkylation with, for example, ethylene oxide, propylene oxide, and/or butylene oxide, by alkylation with, for example, methyl halides and/or dimethyl sulfate, by acylation with carboxylic acid halides, or by saponifying deacetylation, is also possible. Thickening ingredients are contained in the agents according to the present invention in quantities of preferably 0.05 wt % to 2.5 wt %, in particular 0.1 wt % to 2 wt %; their concentration need not be the same in all the sub-compositions.

The individual sub-compositions, especially when only two are present, are preferably used in identical quantitative proportions. This can easily be achieved by adjusting the viscosity of the sub-compositions and/or the nature of the outflow openings of the chambers of the multi-chamber container, in particular by adapting the diameter of the oufflow openings, so that the user of the agent obtains, by simply pouring or squeezing out of the multi-chamber container, a quantity of liquid washing agent that is immediately usable, for example the quantity necessary for one washing cycle in a washing machine. It is preferred if the first and/or each further sub-composition exhibits a viscosity (ascertained, for example, using a Brookfield rotary viscosimeter, spindle no. 3, 20 rpm, room temperature) in the range from 700 mpa.s to 1000 mPa.s.

As used herein, and in particular as used herein to define the elements of the claims that follow, the articles “a” and “an” are synonymous and used interchangeably with “at least one” or “one or more,” disclosing or encompassing both the singular and the plural, unless specifically defined otherwise. The conjunction “or” is used herein in its inclusive disjunctive sense, such that phrases formed by terms conjoined by “or” disclose or encompass each term alone as well as any combination of terms so conjoined, unless specifically defined otherwise. All numerical quantities are understood to be modified by the word “about,” unless specifically modified otherwise or unless an exact amount is needed to define the invention over the prior art.

### EXAMPLES

By simple mixing of the ingredients indicated in the table below in the quantities indicated (in wt % relative to the sub-composition), surfactant- and enzyme-containing sub-compositions T1 and T2 were prepared. These were respectively introduced into one chamber of a double-chamber bottle made of polyethylene comprising two chambers of identical size (volume of each=750 ml), and the respective second chamber of the bottle was filled with the same quantity of a 5-wt % aqueous phthalimidoperoxohexanoic acid preparation P (Eureco® L, manufactured by Ausimont).

Table: Surfactant- and enzyme-containing sub-compositions (wt %)

| | T1 | T2 |
|---|---|---|
| Nonionic surfactant I^{a)} | 24 | — |
| Nonionic surfactant II^{b)} | — | 22.5 |
| Anionic surfactant I^{c)} | 16 | — |
| Anionic surfactant II^{d)} | — | 40 |
| Sodium citrate | 2 | — |
| Phosphonate^{e)} | 0.5 | 0.6 |
| Polyacrylate^{f)} | 1 | — |
| Protease^{g)} | 1.4 | 1.6 |
| Amylase^{h)} | 0.1 | 0.2 |
| Cellulaseⁱ⁾ | 0.04 | 0.06 |
| Glycerol | 7.5 | 1 |
| Ethanol | 1 | 3.5 |
| Propylene glycol | — | 5 |
| Boric acid | 1 | — |
| Colorants and fragrances | 1.5 | 1.5 |
| Water | to make 100 | to make 100 |

^{a)}C₁₂₋₁₆ fatty alcohol-1,4-glucoside and septuply ethoxylated C₁₂₋₁₈ fatty alcohol, weight ratio 1:5
^{b)}C₁₂₋₁₄ fatty alcohol, quadruply propoxylated and quintuply ethoxylated
^{c)}C₁₂₋₁₄ fatty alcohol + 2-EO-sulfate sodium salt and palm kernel oil fatty acid sodium salt, weight ratio 1:1
^{d)}Linear alkyl benzenesulfonate sodium salt and palm kernel oil fatty acid ethanolamine salt, weight ratio 1:1
^{e)}Diethylenetriamine pentamethylene phosphonic acid, heptasodium salt
^{f)}Acusol ® 820
^{g)}Alcalase ® 2.5 L
^{h)}Termamyl ® 300 L
ⁱ⁾Carezyme ® 4500 L

By simple pouring, 100 ml (corresponding to 50 ml T1 or T2 and 50 ml P) or 75 ml (corresponding to 37.5 ml T1 or T2 and 37.5 ml P), in each case, of the two-component agents was measured out into the dispenser of a washing machine, and textiles provided with standardized stains were washed therewith. For comparison, the surfactant- and enzyme-containing sub-compositions T1 and T2 alone, as well as a commercially available compacted-powder universal washing agent, were tested under the same conditions.

1. A liquid washing agent composition containing 7.5 wt % to 80 wt % of one or more surfactants, said composition comprising at least two separate aqueous sub-compositions, a first sub-composition comprising one or more organic peracids and a second sub-composition comprising one or more enzymes.

2. The composition of claim 1, wherein the first sub-composition comprises 1 wt % to 25 wt % of the one or more organic peracids.

3. The composition of claim 2, wherein the first sub-composition comprises 2 wt % to 20 wt % of the one or more organic peracids.

4. The composition of claim 1, wherein the first sub-composition comprises 6-phthalimidoperoxohexanoic acid.

5. The composition of claim 1, wherein the first sub-composition has an acid pH.

6. The composition of claim 5, wherein the first sub-composition has a pH of pH 2.5 to pH 6.

7. The composition of claim 6, wherein the first sub-composition has a pH of pH4 to pH 5.

8. The composition of claim 1, wherein the second sub-composition or each of the further sub-compositions comprises one or more surfactants.

9. The composition of claim 8, wherein the second sub-composition or the further sub-compositions taken together comprise a mixture of one or more nonionic and one or more anionic surfactants.

10. The composition of claim 9, wherein the. weight ratio of anionic surfactant to nonionic surfactant is 10:1 and 1:10.

11. The composition of claim 10, wherein the weight ratio of anionic surfactant to nonionic surfactant is 7:5:1 and 1:5.

12. The compostion of claim 11, wherein the weight ratio of anionic surfactant to nonionic surfactant is 5:1 and 1:2.

13. The composition of claim 1, containing 7.5 wt % to 70 wt % of one or more surfactants.

14. The composition of claim 13, containing 10 wt % to 60 wt % of one or more surfactants.

15. The composition of claim 14, containing 12.5 wt % to 50 wt % of one or more surfactants.

16. The composition of claim 1, wherein the second sub-composition comprises one or more of protease, amylase, and cellulase.

17. The composition of claim 1, wherein the second sub-composition has an alkaline pH.

18. A package of washing agent comprising the composition of claim 1 having a multi-chamber container having a chamber corresponding to each sub-compositions, and only one of the sub-compositions being present in each of the chambers.
